(19) United States
(12) Patent Application Publication
(10) Pub. No.: US 2016/0201379 A1
(43) Pub. Date: Jul. 14, 2016

(54) CONCEALED WALL SAFE WITH ENHANCED LOCKING MECHANISM

(71) Applicant: FRANK C. DUTRA, MORGAN HILL, CA (US)

(72) Inventor: FRANK C. DUTRA, MORGAN HILL, CA (US)

(21) Appl. No.: 14/990,044

(22) Filed: Jan. 7, 2016

Related U.S. Application Data
(60) Provisional application No. 62/102,967, filed on Jan. 13, 2015.

(51) Int. Cl. E05G 1/00; E05B 65/00; E05G 1/04; A47B 67/00; A47B 81/00

(52) U.S. Cl. CPC E05G 1/005; A47B 67/005; A47B 81/005; E05G 1/04; E05B 65/0075

(57) ABSTRACT

A concealed wall safe coupled to studs within an interior wall and having an enhanced locking mechanism to prevent unauthorized access to stored accessories. The safe includes a housing member coupled to the studs and positioned behind an opening in the interior wall, a door pivotably mounted to the housing member and able to adjust to an open position or closed position, and a locking assembly coupled to the door and having a rotary knob and a pair of arms coupled thereto. The rotary knob is adjusted in a first direction to draw the arms inward to disengage with the housing member, thereby permitting the door to pivotably adjust to the open and closed positions. The rotary knob is adjusted in a second direction to extend the arms outward to engage with the housing member, thereby permitting the door to remain locked when in the closed position.

### RELATED APPLICATION

The application claims priority to provisional patent application U.S. Ser. No. 62/102,967 filed on Jan. 13, 2015, the entire contents of which b herein incorporated by reference.

### BACKGROUND

The embodiments herein relate generally to safes and concealed storage compartments.

Safes are common devices used by individual to store valuables such as cash, jewelry, electronics, firearms, or other highly regarded items. These safes typically have a locking mechanism to prevent access to the valuables by unauthorized individuals. Although traditional safes protect a user's belongings, several disadvantages exist. For example, traditional safes are generally bulky and heavy items that are difficult to install in a home. Further, these safes have pre-molded storage areas and/or shelves that do not permit a user to configure in order to maximize interior space for certain items. Lastly, these safes are typically situated in open areas, closets or other locations that are relatively visible to burglars.

Several concealable wall mounted storage compartments exist as disclosed in U.S. Patent Application Publication 2014/0103785. These devices comprise one or more receptacles for storing items. The receptacles are covered by a sliding cover and/or ornamental item to conceal the receptacles. However, these storage compartments are limited because they comprise a simple locking mechanism that docs not adequately protect the stored items. Burglars or other individuals with tools and/or sufficient knowledge may easily break these simple locking mechanisms and gain access to stored valuables.

As such, mere is a need in the industry for a concealed wall safe that addresses the limitations of the prior art, which comprises an enhanced locking mechanism that provides greater security for stored valuables.

### SUMMARY

A concealed wall safe coupled to studs within an interior wall and configured to store a plurality of accessories is provided. The concealed wall safe comprises an enhanced locking mechanism to prevent unauthorised access to the stored accessories. The wall safe comprises a housing member coupled to first and second studs and positioned behind an opening in the interior wall, the housing member defined by outer walls to create a storage compartment configured to store the accessories, a door pivotably mounted to the housing member proximate the first stud and configured to adjust to an open position to expose the interior wall opening or a closed position to seal the interior wall opening, and a locking assembly coupled to the door and comprising a rotary knob and a pair of arms coupled thereto, where in the rotary knob is adjusted in a first direction to draw the arms inward to disengage with the housing member, thereby permitting the door to pivotably adjust to the open and closed positions, wherein the rotary knob is adjusted in a second direction to extend the arms outward to engage with the housing member, thereby permitting the door to remain locked when in the closed position.

### BRIEF DESCRIPTION OF THE DRAWINGS

The detailed description of some embodiments of the invention will be made below with reference to the accompanying figures, wherein the figures disclose one or more embodiments of the present invention.

FIG. 1 depicts a perspective view of certain embodiments of the wall safe shown in use in a concealed configuration;

FIG. 2 depicts a perspective view of certain embodiments of the wall safe shown in use in an unconcealed configuration;

FIG. 3 depicts a perspective view of certain embodiments of the wall safe depicting a cutaway portion;

FIG. 4 depicts a section view of certain embodiments of the wall sale taken along line 4-4 in FIG. 3;

FIG. 5 depicts a section view of certain embodiments of the wail safe taken along line 5-5 in FIG. 3;

FIG. 6 depicts a perspective view of certain embodiments of the wall safe depicting a locking assembly in a locked configuration;

FIG. 7 depicts a section view of certain embodiments of the wall safe taken along line 7-7 in FIG. 6;

FIG. 8 depicts a perspective view of certain embodiments of the will safe;

FIG. 9 depicts a perspective view of certain embodiments of the wall safe;

FIG. 10 depicts a perspective view of certain embodiment of the wall safe depicting a locking assembly shown in an unlocked configuration;

FIG. 11 depicts a perspective view of certain embodiments of the wall safe depicting a locking assembly shown in an unlocked configuration;

FIG. 12 depicts a perspective view of certain embodiment of the wall safe shown in an unconcealed and unlocked configuration;

FIG. 13 depicts a section view of certain embodiments of the wall safe taken along line 13-13 in FIG. 12;

FIG. 14 depicts a perspective view of an alternative embodiment of the wall safe;

FIG. 15 depicts a perspective view of an accessory for use with certain embodiments of the wall safe;

FIG. 16 depicts a perspective view of an accessory for use with certain embodiments of the wall safe;

FIG. 17 depicts a perspective view of in accessory for use with certain embodiments of the wall safe;

FIG. 18 depicts a perspective view of an accessory for use with certain embodiments of the wall safe;

FIG. 19 depicts a perspective view of in accessory for use with certain embodiments of the wall safe;

FIG. 20 depicts a perspective view of an accessory for use with certain embodiments of the wall safe;

FIG. 21 depicts a perspective view of an accessory for use with certain embodiments of the wall safe;

FIG. 22 depicts a perspective view of an accessory for use with certain embodiments of the wall safe; and

FIG. 23 depicts a perspective view of an accessory for use with certain embodiments of the wall safe.

### DETAILED DESCRIPTION OF CERTAIN EMBODIMENTS

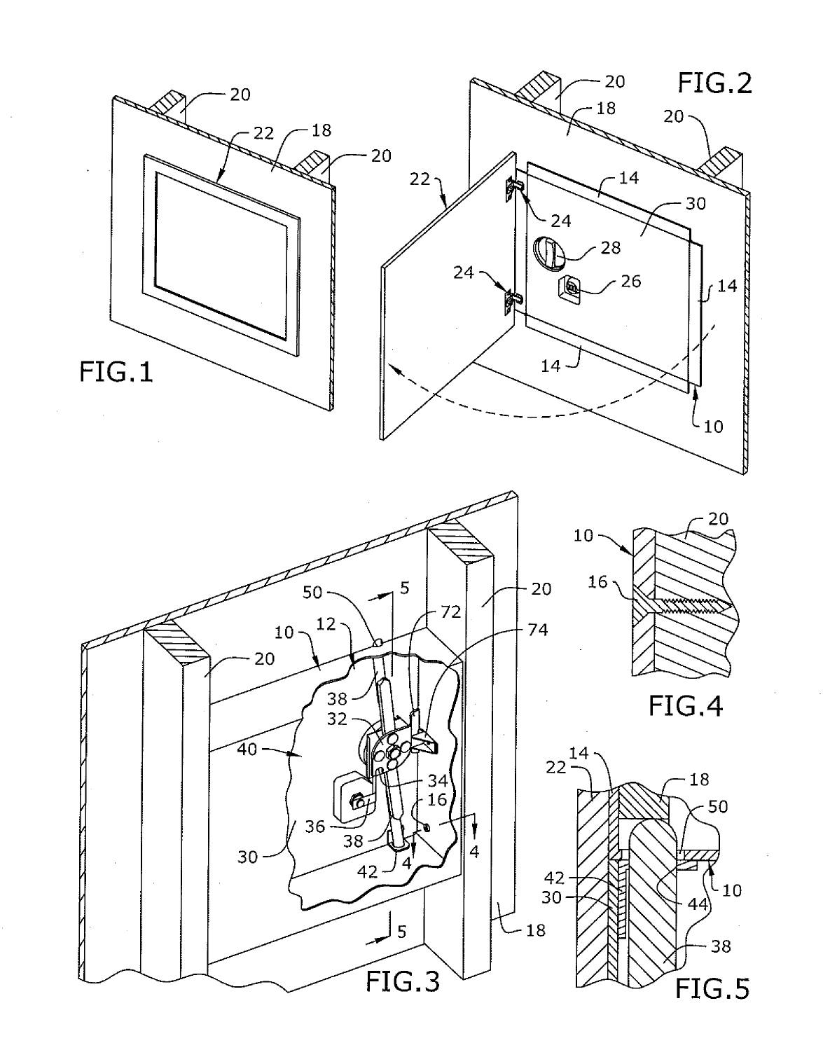

As depicted in FIGS. 1-3, the concealed wall safe is disposed within wall 18 and coupled to studs 20 to store a variety of accessories (not shown). The wall safe generally comprises safe body 10, safe door 30, decoy member 22, rotary knob 28, combination lock knob 26, combination lock rotary latch 36 and rotary hub locking mechanism 32.

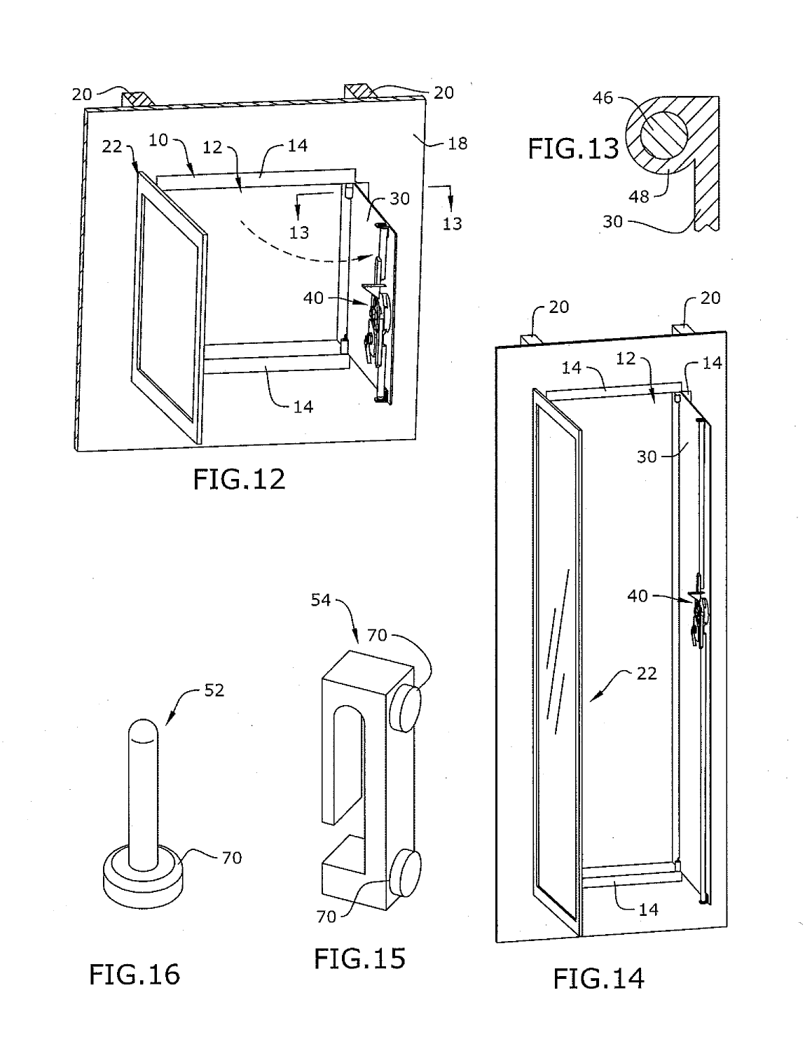

Safe body 10 is preferably made from steel and is disposed within an opening in wall 18. Safe body 10 comprises interior walls to create safe compartment 12. As depicted in FIGS. 2-4, safe body 10 comprises safe flange 14 and is mechanically coupled to studs 20 by stud fasteners 16. Any number of stud fasteners 16 or alternative fastening components may be used instead. Decoy member 22 is pivotably mounted to safe body 10 by hinges 24. Decoy member 22 can be any item designed to conceal the wall safe such as a framed picture, painting, other artwork mirror, or the like. As depicted in FIGS. 12-13, safe door 30 is pivotably mounted to safe body 10 by fastening components such as hinge post 46 and hinge post receivers 48. As shown in FIG. 1, decoy member 22 is configured to overly safe door 30 when in the closed position.

Locking assembly 40 comprises rotary hub locking mechanism 32 and combination lock rotary latch 36 coupled to the inferior face of sale door 30. Rotary knob 28 is coupled to the exterior face of safe door 30 and is operably connected to rotary hub looking mechanism 32. Combination lock knob 25 is coupled to the exterior face of safe door 30 and is operably connected to combination lock rotary latch 36. It shall be appreciated that combination lock knob 26 may be replaced with any alternative type of key mechanism including, but not limited to, manual combination locks, electronic locks, magnetic key cards, RFID devices, fingerprint scanners, retina scanners, other biometric devices, or the like.

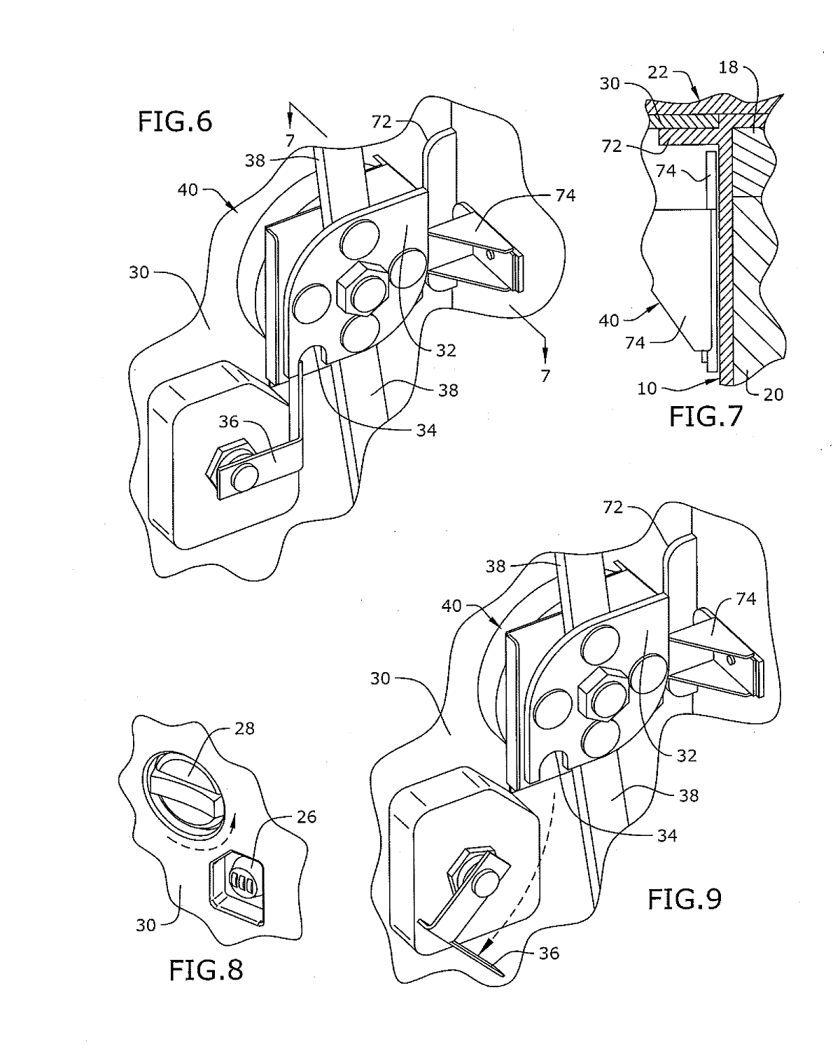

Rotary hub locking mechanism 32 comprises notch 34, a pair of locking arms 38 and L-bracket lock arm 74 coupled thereto. In a locked position, each looking arm 38 engages with safe body 10. More specifically, each locking arm 38 is inserted through locking bracket hole 44 in safe body locking bracket 42 and safe body hole 50 in safe body 10 as depicted in FIG. 5. In this position, each locking arm 38 is engaged with safe body 10. As depicted in FIGS. 6-7, in the locked position, L-bracket lock arm 74 of rotary hub locking mechanism 32 is positioned directly behind sale body side lock bar 72, which is coupled to an interior wall of safe body 10. In this configuration, pivotal movement of safe door 30 is restricted and maintained in the closed position. This is because L-bracket lock arm 74 contacts safe body side lock bar 72 if a user (not shown) attempts to open safe door 30. As an additional security mechanism, combination lock rotary latch 36 is configured to engage with notch 34 of rotary hub locking mechanism 32. This engagement prevents the rotation of rotary hub locking mechanism 32.

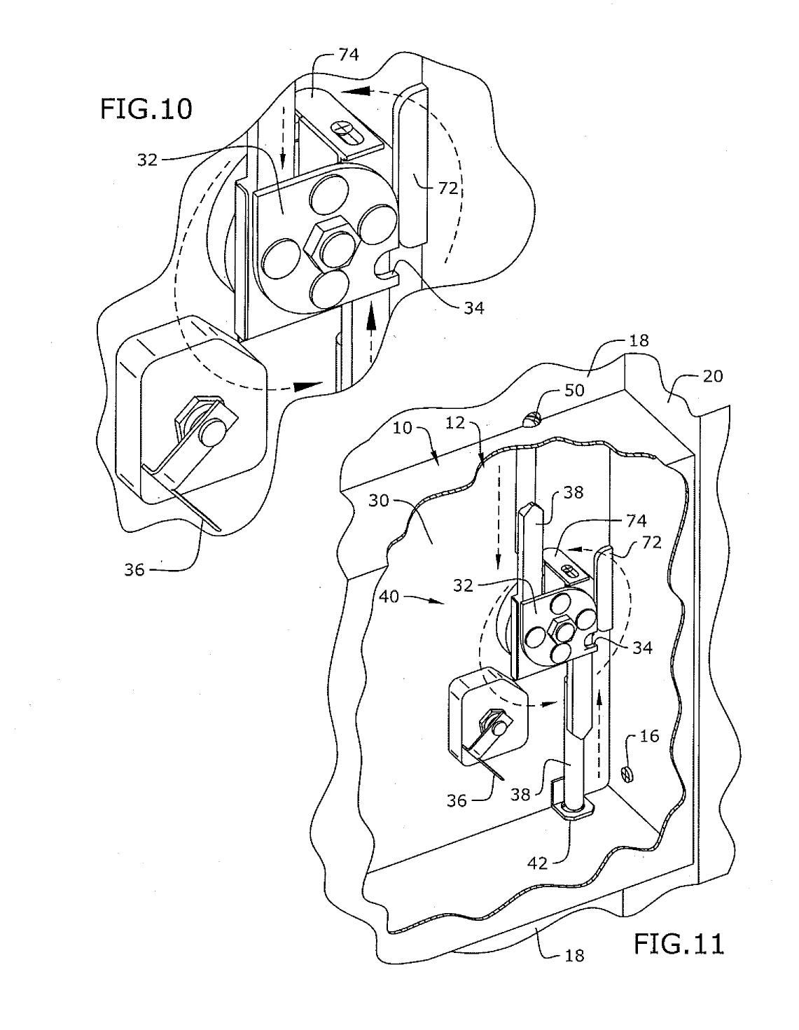

FIG. 6 depicts safe door 30 and locking assembly 40 in the closed and locked position with combination lock rotary latch 36 engaged with notch 34 of rotary hub locking mechanism 32 and L-bracket lock arm 74 positioned behind safe body side lock bar 72. To unlock locking assembly 40, a user (not shown) enters a code to activate combination lock knob 26. As shown in FIGS. 8-9, this permits combination lock rotary latch 36 to disengage with notch 34 of rotary hub locking mechanism 32. The user then rotates rotary knob 28 in a first direction. As depicted in FIGS. 10-11, this rotation causes L-bracket lock arm 74 to rotate away from safe body side lock bar 72. At the same time, locking arms 38 are drawn inward to disengage with safe body looking brackets 42 and safe body 10. In the unlocked position, both safe door 30 and decoy member 22 are free to pivotably adjust to open positions to expose safe compartment 12 as shown in FIG. 12. FIG. 14 depicts an alternative embodiment in which decoy member 22 is a full-sized mirror.

Once the wall safe is opened and unlocked, any variety of accessories (not shown) may be stored therein. To lock locking assembly 40, safe door 30 is closed. Rotary knob 28 is rotated in a second direction opposite the first direction. This rotation causes L-bracket lock arm 74 to rotate behind safe body side lock bar 72. At the same time, locking arms 38 extend outward to engage with safe body locking brackets 42 and safe body 10. Combination lock knob 26 is activated to permit combination look rotary latch 36 to engage with notch 34 of rotary hub locking mechanism 32. Decoy member 22 is closed to overlap safe door 30 to conceal the wall safe.

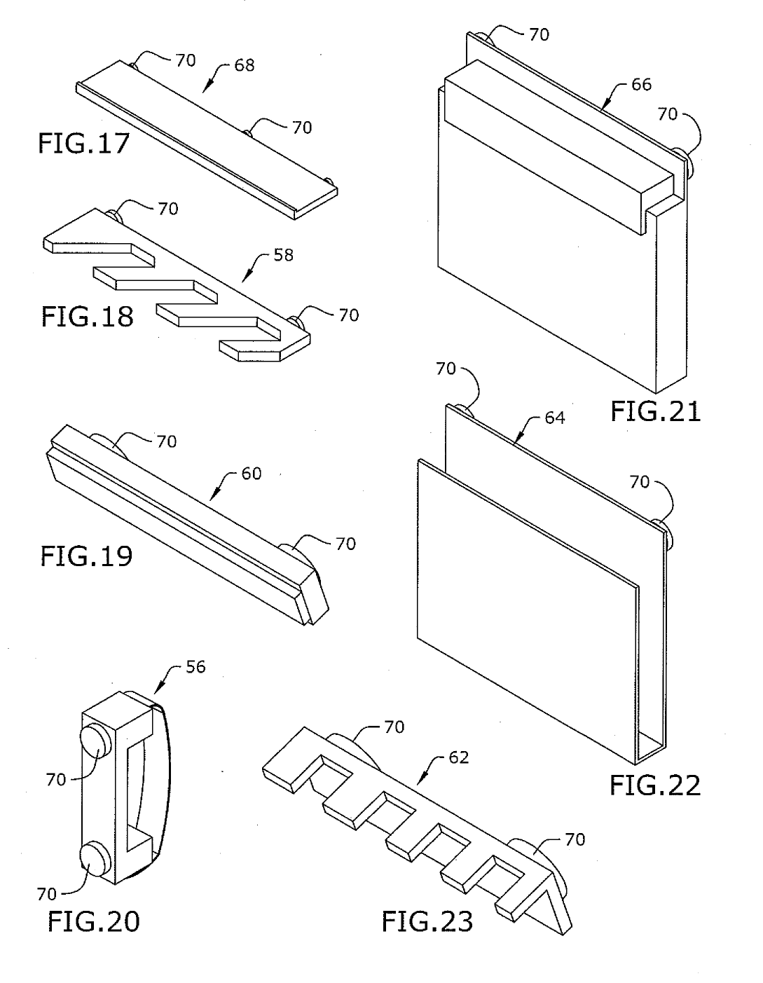

It shall be appreciated that a variety of accessories may be stored within the wall safe. Each accessory may comprise one or more magnets to secure the item to an interior wall of safe body 10. The following is a list of exemplary, but non-limiting accessories that may be used. FIG. 15 depicts rife shotgun holder 54 and magnets 70. FIG. 16 depicts pistol holder 52 and magnet 70. FIG. 17 depicts shelf 68 and magnets 70. FIG. 18 depicts AR magazine holder 58 and magnets 70. FIG. 10 depicts single stack magazine holder 60 and magnets 70. FIG. 20 depicts strap holder 56 and magnets 70. FIG. 21 depicts notebook holder 66 and magnets 70. FIG. 22 depicts document holder 64 and magnets 70. FIG. 23 depicts double stack magazine holder 62 and magnets 70.

It shall be appreciated that the components of the wall safe described in several embodiments herein may comprise any alternative known materials in the field and be of any color, size and/or dimensions. It shall be appreciated that the components of the wall safe described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A concealed wall safe coupled to studs within an interior wall and configured to store a plurality of accessories, the concealed wall safe comprising an enhanced locking mechanism to prevent unauthorized access to the stored accessories, the wall safe comprising:
a housing member coupled to first and second studs and positioned behind an opening in the interior wall, the housing member defined by outer walls to create a storage compartment configured to store the accessories;
a door pivotably mounted to the housing member proximate the first stud and configured to adjust to an open position to expose the interior wall opening or a closed position to seal the interior wall opening; and
a locking assembly coupled to the door and comprising a rotary knob and a pair of arms coupled thereto;
wherein the rotary knob is adjusted in a first direction to draw the arms inward to disengage with the housing member, thereby permitting the door to pivotably adjust to the open and closed positions, wherein the rotary knob is adjusted in a second direction to extend the arms outward to engage with the housing member, thereby permitting the door to remain locked when in the closed position.

2. The wall safe of claim 1, further comprising a bar member coupled to the first stud and a bracket arm coupled to the rotary knob, wherein the rotary knob adjustment in the first direction rotates the bracket arm away from the bar member to permit the door to adjust to the open and closed positions, wherein the rotary knob adjustment in the second direction, rotates the bracket arm behind the bar member, thereby restricting the door from pivotal movement in the closed position.

3. The wall safe of claim 2, wherein each of the pair of arms of the rotary knob is configured to slidably adjust within an opening in a L-bracket coupled to the housing member.

4. The wall safe of claim 3, wherein the locking assembly comprises a secondary locking member comprising a rotatable latch, wherein the rotatable latch is configured to engage with a notch in the rotary knob to prevent rotation of the rotary knob, wherein the rotatable latch is configured to disengage with the notch to permit rotation of the rotary knob.

5. The wall safe of claim 4, wherein the rotatable latch of the secondary locking member is controlled by a combination lock.

6. The wall safe of claim 4, further comprising a decoy member pivotably mounted to the housing member proximate the second stud, the decoy member configured to overlap the door.

7. The wall safe of claim 6, wherein the decoy member is a framed artwork.

8. The wall safe of claim 6, wherein the decoy member is a mirror.

9. The wall safe of claim 6, wherein the plurality of accessories is selected from the group consisting of a shotgun holder pistol holder, shelf member, magazine holder, strap holder, notebook holder and document holder.

10. The wall safe of claim 9, wherein each of the plurality of accessories is detachably coupled to the housing member by at least one magnet.
